(19) United States
(12) Patent Application Publication
(10) Pub. No.: US 2015/0240848 A1
(43) Pub. Date: Aug. 27, 2015

(54) JOINING APPARATUS OF MODULE ACTUATOR

(71) Applicant: Robobuilder CO., Ltd., Seoul (KR)

(72) Inventors: Hong-Min JANG, Goyang-si (KR); Seong-Hoon LEE, Goyang-si (KR); Dong-Geun KIM, Seoul (KR)

(73) Assignee: ROBOBUILDER CO., LTD., Seoul (KR)

(21) Appl. No.: 14/197,908

(22) Filed: Mar. 5, 2014

(30) Foreign Application Priority Data
Feb. 24, 2014 (KR) 10-2014-0021601

(51) Int. Cl. F16B 5/12

(52) U.S. Cl. CPC F16B 5/12

(57) ABSTRACT

Provided is a modular actuator joining device. A housing forms an external appearance of a modular actuator. Coupling pieces are formed along opposite end edges of outer surfaces of the housing. Accordingly, the coupling pieces formed with first to third fastening parts. Nuts are installed inside fastening holes that form the fastening parts such that fasteners are fastened to the fastening parts. Modular actuators may be variously joined to each other. In addition, any other component may be variously joined to the modular actuator. Further, two or more modular actuators may be joined to each other without using a connecting member.

### BACKGROUND OF THE INVENTION

1. Field of the Invention

The present invention relates to a modular actuator joining device, and more particularly, to a modular actuator joining device which is configured to be capable of being joined in various directions.

2. Description of the Prior Art

A modular actuator is used, for example, in a modular robot. The modular robot refers to a robot of which joints, wheels or the like are modularized to be capable of being assembled so as to simply fabricate the robot unlike a robot which is fabricated from beginning to end by a manufacturer.

FIG. 1 is a perspective view illustrating an example of a conventional modular robot.

The conventional modular robot 10 includes, as basic units, a plurality of actuators 20 that conduct actions of the robot 10, a plurality of connecting members 30 that interconnect the plurality of actuators 20, and a Main Processor Unit (MPU) (not illustrated) that controls the plurality of actuators 20. Each actuator 20 is provided with a control unit (not illustrated) that receives a control signal from the MPU so as to control detailed actions of the actuator 20. The MPU and the control unit maintain a master-slave relationship so as to control various actions of the modular robot 10.

Such a modular robot 10 enables substantial reduction of time and personnel expenses required for fabricating it as compared with other types of robots. In addition, such a modular robot is very effective since when the robot has a breakdown, only the corresponding components may be replaced, and when improving the performance of the robot, some elements may be replaced rather than re-fabricating the robot entirely.

A plurality of modular actuators 20 used in such a modular robot 10 should be interconnected with each other. However, due to the construction of the actuators 20, fasteners may be fastened to anchoring pieces in only one direction. Accordingly, in order to variously interconnect the actuators 20, it is necessary to use separate connecting members 30.

However, when the connecting members 30 are used in the modular robot 10, the overall number of components is increased. Since the connecting members 30 should be assembled to all the actuators 20 to be interconnected, a number of fasteners are used and a lot of time is required for assembly.

### PRIOR ART DOCUMENT

### Patent Document

Korean Patent Laid-Open Publication No. 10-2009-0027302

Korean Patent Laid-Open Publication No. 10-2006-0123020

### SUMMARY OF THE INVENTION

Accordingly, the present invention has been made to solve the above-mentioned problems and the present invention provides a modular actuator joining device which enables modular actuators or a modular actuator and a component other than the modular actuator to be variously joined with each other.

In order to achieve the above-mentioned objects, according to an aspect of the present invention, there is provided a modular actuator joining device including: a housing that forms an external appearance and encloses a driving source therein such that a driving force of the driving source can be transferred to the outside through a driving shaft; a coupling piece formed on an outer surface of the housing to have a predetermined thickness and protruding by a predetermined width; a first fastening part where a first fastening hole is formed to be opened to another outer surface of the coupling piece so that a fastener is fastened to the first fastening hole so as to join a component; and a second fastening part where a second fastening hole is formed to be opened to another outer surface of the coupling piece in a direction orthogonal to an opening direction of the first fastening hole so that a fastener is fastened to the second fastening hole to join another component.

The first fastening hole that forms the first fastening part is formed through the coupling piece in a thickness direction, and a nut is installed inside the first fastening hole.

The second fastening hole that forms the second fastening part is formed to be opened to a front end surface of the coupling piece and a nut is installed inside the second fastening hole.

The modular actuator joining device further includes a third fastening part at still another outer surface of the coupling piece. A third fastening opening is formed to be opened in a direction orthogonal to both the opening directions of the first fastening hole and the second fastening hole.

The third fastening part is formed in the outer surface positioned opposite to the driving shaft among the outer surfaces of the coupling piece.

The housing includes a main housing and first and second housings installed at opposite ends of the main housing, and a plurality of coupling pieces are formed to protrude in opposite directions from opposite ends of the first and second end housings.

The coupling pieces are joined with covers, respectively, so that inner spaces formed in the coupling pieces are shielded by the covers, and nut seats are formed in any of the inner spaces. Nuts that form the first and second fastening parts are seated on the nut seats, respectively.

The nut seats are formed on at least one side of the first and second end housings and inner surfaces of the covers.

The coupling piece is formed with a cable hooking slot where a cable is hooked to be fixed, the cable hooking slot being opened to all of a front end surface of the coupling piece and outer surfaces adjacent to the front end surfaces.

According to the modular actuator joining device of the present invention, the following effects can be obtained.

In the modular actuator joining device of the present invention, the fastening holes of the fastening parts formed in the coupling pieces are opened in different directions. Accordingly, in the present invention, fasteners may be fastened to the fastening parts in various directions such that a component joined to the actuator may be joined in various directions. Due to the structural features, the number of connecting members required for joining actuators or for joining a component and an actuator may be minimized. As a result, the overall number of components used in the final product and the number of steps during assembly or disassembly of the product can be reduced.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a conventional modular robot;

FIG. 2 is a perspective view illustrating an exemplary embodiment of a modular actuator joining device according to the present invention;

FIG. 3 is a perspective view illustrating the exemplary embodiment of FIG. 2 viewed from a different direction;

FIG. 4 is a perspective view illustrating the exemplary embodiment of FIG. 2 from which covers are disassembled;

FIG. 5 is an enlarged perspective view illustrating an inner configuration of a coupling piece of the exemplary embodiment of FIG. 2;

FIG. 6 is a front view illustrating the construction of the second exemplary embodiment of FIG. 2; and

FIGS. 7 to 10 are use state views illustrating various methods of joining modular actuators using a modular actuator joining device of an exemplary embodiment of the present invention;

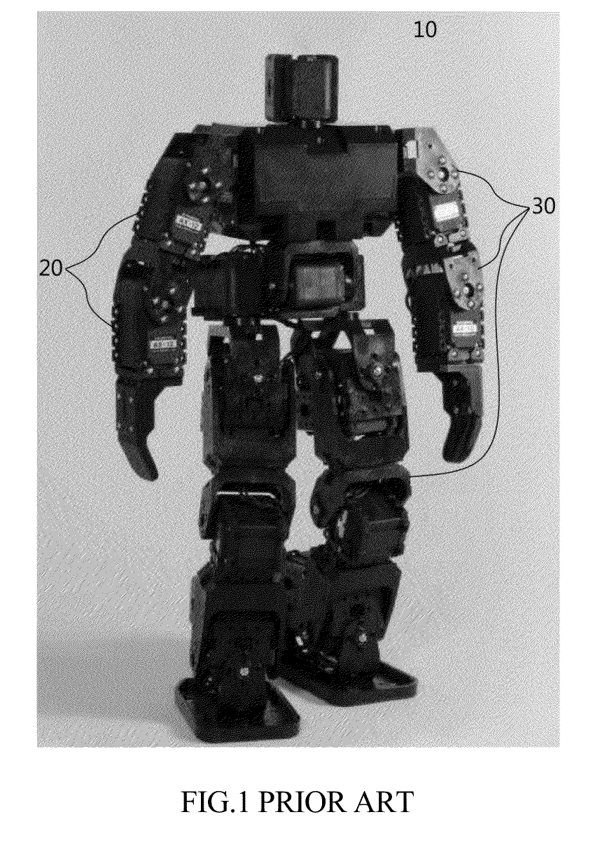

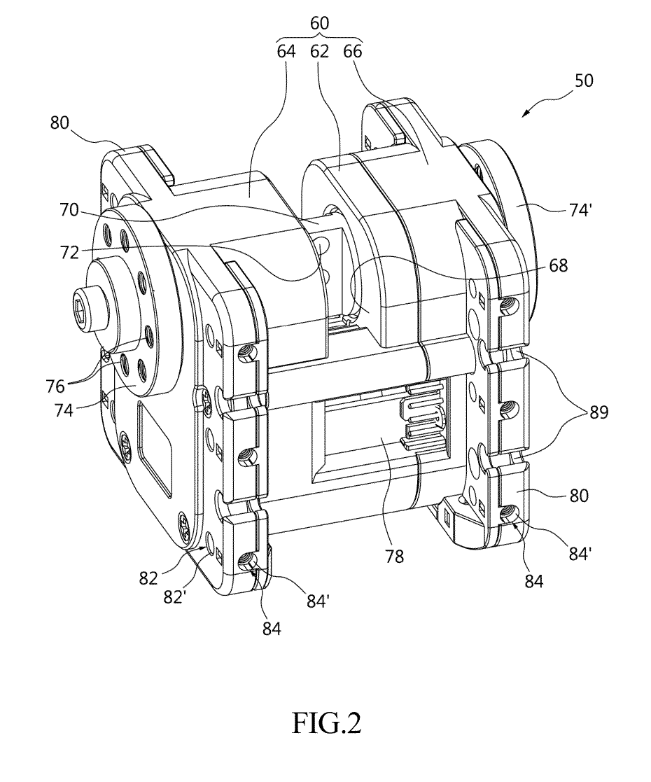

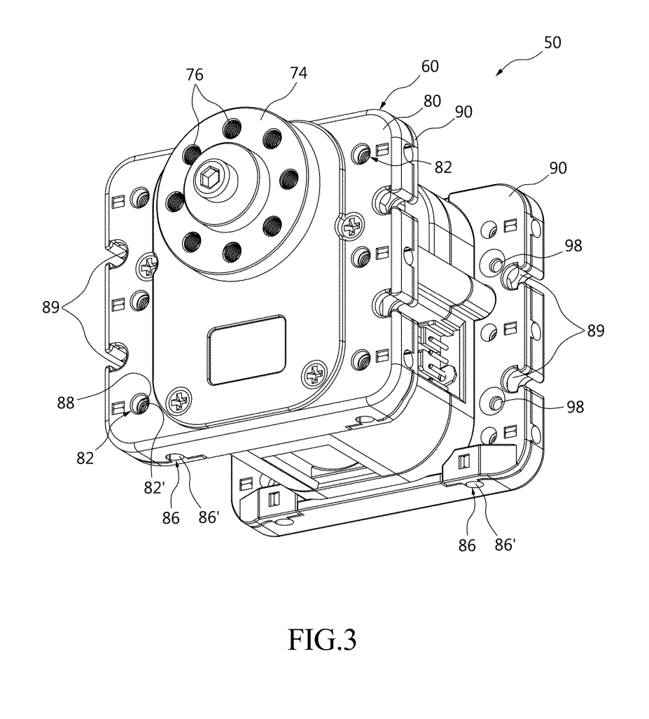

### DETAILED DESCRIPTION OF THE EXEMPLARY EMBODIMENTS

Hereinafter, a modular actuator joining device according to an exemplary embodiment of the present invention will be described in detail with reference to the accompanying drawings.

Hereinbelow, an exemplary embodiment of the present invention will be described through illustrative drawings. It shall be noted that in the drawings, the same elements will be assigned the same reference numerals if possible. In describing the exemplary embodiments of the present invention, a detailed description for a related construction or function will be omitted when it may make the contents of exemplary embodiments of the present invention rather unclear.

In addition, in describing elements of an exemplary embodiment of the present invention, terms such as “first”, “second”, “A”, “B”, “(a)”, and “(b)” may be used. Such terms are used merely to distinguish a corresponding element from any other element but an essence, a sequence, an order, or the like of the corresponding element is not limited by the terms. When it is described that an element is “connected”, “joined” or “coupled” to any other element, it shall be understood that although the corresponding element may be directly connected or coupled to the other element, still another element may be “connected”, “joined” or “coupled” therebetween.

According to the drawings, a housing 60 forms an external appearance of a modular actuator 50. In the present exemplary embodiment, the housing 60 is configured such that first and second end housings 64 and 66 are positioned at opposite ends of a main housing 62, respectively. The housing 60 is generally formed in a substantially hexahedral shape. Of course, the housing 60 does not form a complete hexahedral shape since coupling pieces 80 to be described below protrude from opposite ends of the first and second end housings 64 and 66.

The main housing 62 forms a frame of the housing 60 within which a space is formed in which a printed circuit board, a motor, a gear train (not illustrated), etc. are provided. The first end housing 64 and the second end housing 66 are coupled to the opposite sides of the main housing 62, respectively, to form the external appearance of the housing 60 together with the main housing 62, and serve to shield the space formed within the main housing 62 from the outside.

An output opening portion 68 is formed on one side of the main housing 62. The output opening portion 68 is opened to three adjoining outer surfaces of the housing 60 so that the driving force of the motor can be transferred to the outside.

An intermediate output portion 70 is positioned in the output opening portion 68. The intermediate output portion 70 serves to transfer the driving force of the motor to the outside of the housing 60. That is, the intermediate output portion 70 is rotated together with a driving shaft (not illustrated), which receives the driving force of the motor through the gear train, so as to transfer the driving force to the outside of the housing 60. The intermediate output portion 70 is formed with a fastening through-hole 72 to be joined with a component which will receive the power.

The opposite ends of the driving shaft extend through the first and second end housings 64 and 66 to provide the power to the outside. A first output joint 74 and a second output joint 74′ are installed at the opposite ends of the driving shaft, respectively. Of course, the output joints 74 and 74′ illustrated in the drawings do not necessarily have to be installed at the opposite ends of the driving shaft, and any other joints may be mounted on the opposite ends of the driving shaft as long as they are configured to be capable of transferring the driving force of the driving shaft. The output joints 74 and 74′ are each formed in a disc shape and a plurality of fastening through-holes 76 are formed along a circular trace.

A connector seat 78 is formed on the outer surface of the housing 60 and a connector (not illustrated) configured to perform transmission of power and signals to the outside of the actuator 50 is fitted in the connector seat 78. The connector seat 78 is formed on each side of the main housing 62 in the present exemplary embodiment. The connector seat 78 is formed to be recessed on the outer surface of the main housing 62 so as to prevent the connector from protruding to the outside.

The coupling pieces 80 are formed to protrude from outer edges of the housing 60. The coupling pieces 80 are formed to protrude in parallel to each other along the opposite edges of the outer surface of the housing 60. Accordingly, the coupling pieces 80 are formed to protrude at four areas in total. Each of the coupling pieces 80 is formed in a plate shape having a predetermined thickness and protruding by a predetermined width from the outer surface of the housing 60.

The coupling pieces 80 are formed to protrude in opposite directions at the opposite ends of the first and second end housings 64 and 66, respectively. In addition, the coupling pieces 80 on the first end housing 64 and the second coupling pieces 80 on the end housing 66 extend in parallel to each other.

Each of the coupling pieces 80 is formed with a plurality of fastening parts 82, 84 and 86. That is, a first fastening part 82, a second fastening part 84 and a third fastening part 86 are formed on different outer surfaces of each coupling piece 80, respectively.

Each first fastening part 82 is formed with a first fastening hole 82′ to be seen on the corresponding coupling piece 80 when each of the broadest outer surfaces of the first end housing 64 and the second end housing 66 is shown in a front view. Referring to the configuration of each of the first fastening part 82, the first fastening hole 82′ is formed through the coupling piece 80 and a nut 88 to be described later is fixed inside the coupling piece 80 such that the center of the nut 88 coincides with the center of the first fastening hole 82′. One coupling piece 80 is formed with two or more first fastening parts 82. In the present exemplary embodiment, one coupling piece 80 is formed with three first fastening parts 82. The first fastening holes 82′ extend in the thickness direction of the coupling piece 80 through the coupling piece 80.

The second fastening parts 84 are formed on an outer surface which is orthogonal to the outer surface where the first fastening parts 82 are formed, among the outer surfaces of each coupling piece 80. The second fastening parts 84 are formed on the front end surface of the coupling piece 80. The second fastening parts 84 are respectively formed with second fastening holes 84′ to be opened in a direction orthogonal to the opening direction of the first fastening holes 82′ of the first fastening parts 82. Nuts 88 are also installed at the second fastening holes 84′ of the second fastening parts 84. In the present exemplary embodiment, each coupling piece 80 is formed with three second fastening parts 84. Since the second fastening holes 84′ of the second fastening part 84 extend in the width direction of the corresponding coupling piece 80, the second fastening holes 84 do not extend through the coupling piece 80.

The third fastening part 86 is formed in the outer surface which is orthogonal to both outer surfaces where the first fastening parts 82 and the second fastening parts 84 are formed, among the outer surfaces of the corresponding coupling piece 80. That is, the third fastening part 86 is formed in the outer surface having the smallest area and positioned at the side opposite to the intermediate output portion 70 among the outer surfaces of the corresponding coupling piece 80. A nut 88 is also installed at the third fastening hole 86′ of the third fastening part 86. In the exemplary embodiment, one third fastening part 86 is formed in each coupling piece 80. However, two or more third fastening parts 86 may be formed in each coupling piece 80. In addition, the third fastening part 86 is formed in only one end surface of the corresponding coupling piece 80 in the exemplary embodiment. However, the third fastening part 86 may be formed on each of the opposite end surfaces of the corresponding coupling piece 80.

The nuts 88 are installed in the fastening holes 82′, 84′ and 86′ of the fastening parts 82, 84 and 86, respectively. Each of the nuts 88 is a part to which a bolt 88′ which is a fastener for mounting another component or another actuator 60 to the housing 60 of the actuator 50 is fastened. The nuts 88 are fastened inside the fastening parts 82, 84 and 86. Each nut 88 is formed in a polygonal cross section. In the present exemplary embodiment, each nut 88 is formed in a hexagonal cross section.

Each coupling piece 80 is formed with one or more cable hooking slots 89. The cable hooking slots 89 are formed to be opened to three outer surfaces of the coupling piece 80, i.e. the relatively broad opposite side outer surfaces where the first fastening parts 82 are opened and the relatively narrow front end surface of the coupling piece 80 where the second fastening parts 84 are opened. That is, the cable hooking slots 89 are formed by partially cutting the coupling piece 80. A cable extending from a connector seated on the connector seat 78 is hooked in the cable hooking slot 89 to be arranged.

The coupling pieces 80 are provided in the first and second end housings 64 and 66. In the present exemplary embodiment, the coupling pieces 80 are configured by forming the coupling pieces 80 to be partially integrated with the first and second end housing 64 and 66 and coupling separately fabricated covers 90 thereto, respectively.

Each of the coupling pieces 80 is provided with one of the cover 90. The covers 90 shield inner spaces 92 formed in the coupling pieces 80 from the outside and allow the nuts 88 to be fixed. Although the covers 90 are fabricated separately from the first and second end housings 64 and 66 in the exemplary embodiment, it is not essential. The covers 90 may also be integrally fabricated with the first and second end housings 64 and 66 when they are injection molded in a mold in a state where the nuts 88 are put in the mold.

Cover fastening bosses 94 are formed in the inner spaces 92. Screws (not illustrated) are fastened to the cover fastening bosses 94 to fasten the covers 90 to the first and second end housings 64 and 66.

In the inner spaces 92, nut seats 96 are formed and the nuts 88 are seated on the nut seats 96, respectively. The nut seats 96 serve to prevent the nuts 88 installed in the inner spaces 92 from being freely moved and prevent the nuts 88 from being rotated together with the bolts 88′ when the bolts 88′ as fasteners are fastened to the nuts 88.

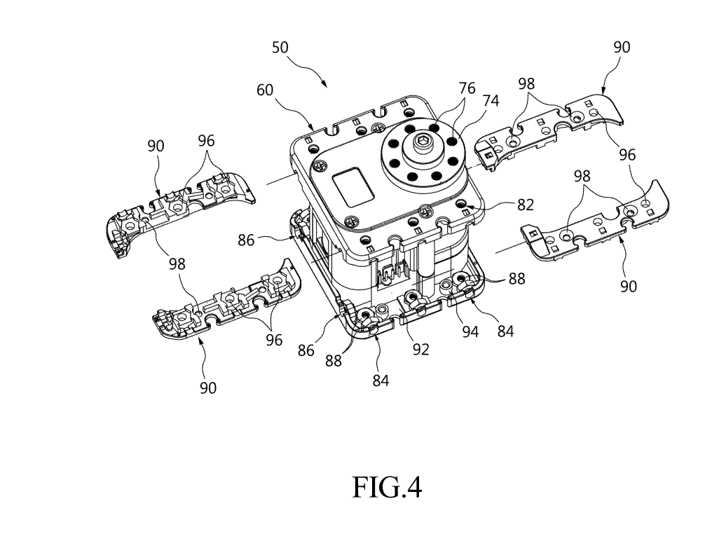

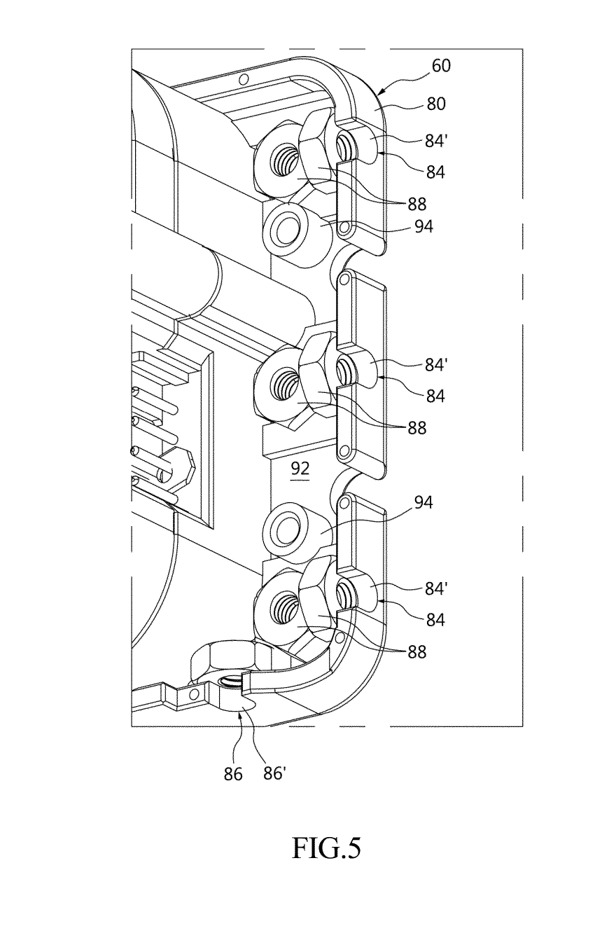

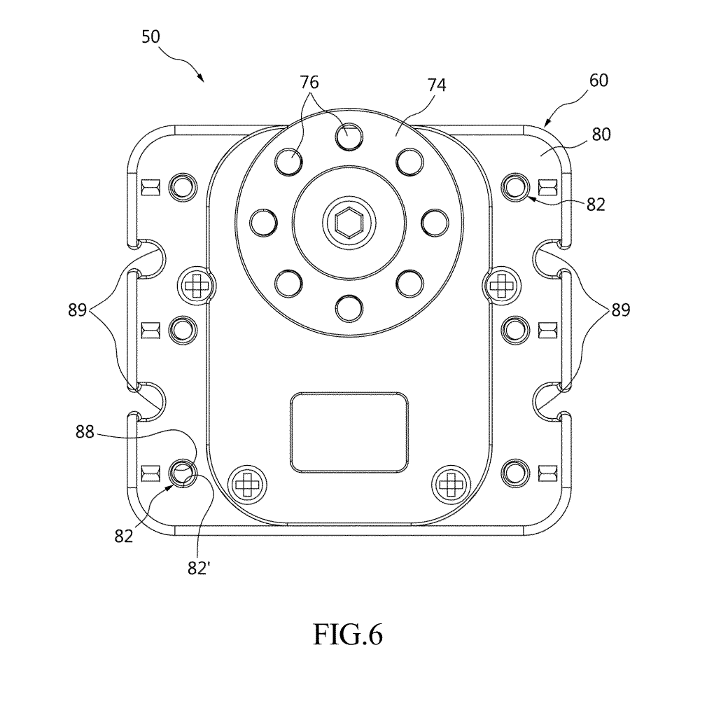

The nut seats 96 may be formed only in the first and second end housings 64 and 66 or only in the covers 90. Alternatively, the nut seats 96 may be formed to be distributed between the first and second end housings 64 and 66 and the inner surfaces of the covers 90. That is, in the case of the first fastening parts 82, the nut seats 96 are formed only on the inner surfaces of the covers 90 as illustrated in FIG. 4. In the case of the second fastening parts 84 and the third fastening parts 86, the nut seats 96 are formed to be distributed between the first and second end housings 64 and 66 and the covers 90. In FIG. 4, the nuts 88 are illustrated as if they are positioned in the inner spaces 92 of the first and second end housings 64 and 66 for the convenience of illustration.

In the covers 90, cover fastening holes 98 are formed at the positions corresponding to the cover fastening bosses 94. When the screws are fastening to the cover fastening bosses 94 through the cover fastening holes 98, the covers 90 are fastened and fixed to the first and second end housings 64 and 66.

Hereinafter, use of a modular actuator joining device according to the present invention as described above will be described in detail.

The modular actuator 50 forms a moving part of a modular robot. Two or more modular actuators 50 are used and connected with each other or a separate component is assembled thereto so as to fabricate a modular robot.

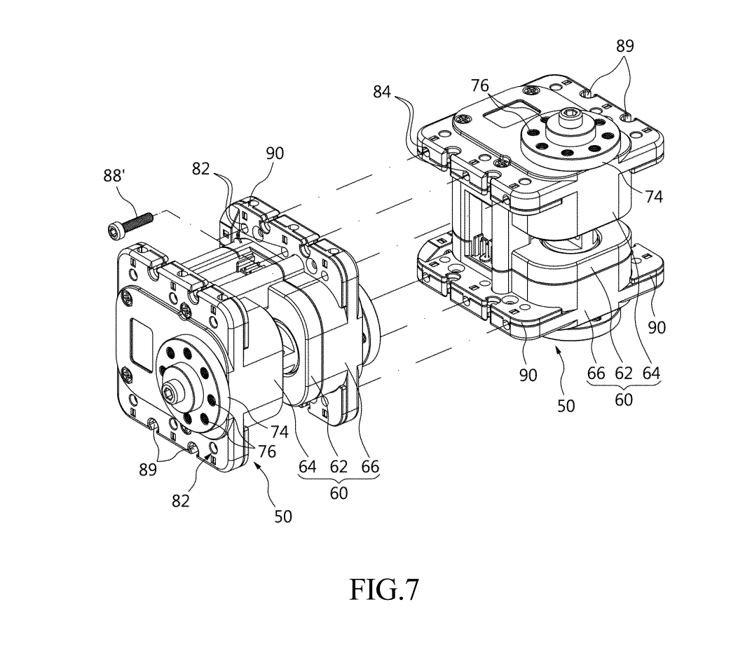

In order to couple the modular actuators 50, the joining device according to the present invention is used in which two modular actuators 50 may be directly joined using the bolts 88′. Such a configuration is illustrated in FIG. 7.

Here, the bolts 88′ are inserted through the first fastening holes 82′ of the first fastening parts 82 of the modular actuator 50 at one side and fastened to the nuts 88 positioned in the second fastening holes 84′ of the second fastening parts 84 existing in the coupling pieces 80 of the modular actuator 50 at the other side. When the two modular actuators 50 are joined to each other in this manner, the driving shafts of the two modular actuators 50 extend in directions orthogonal to each other in a state where they are spatially spaced apart from each other.

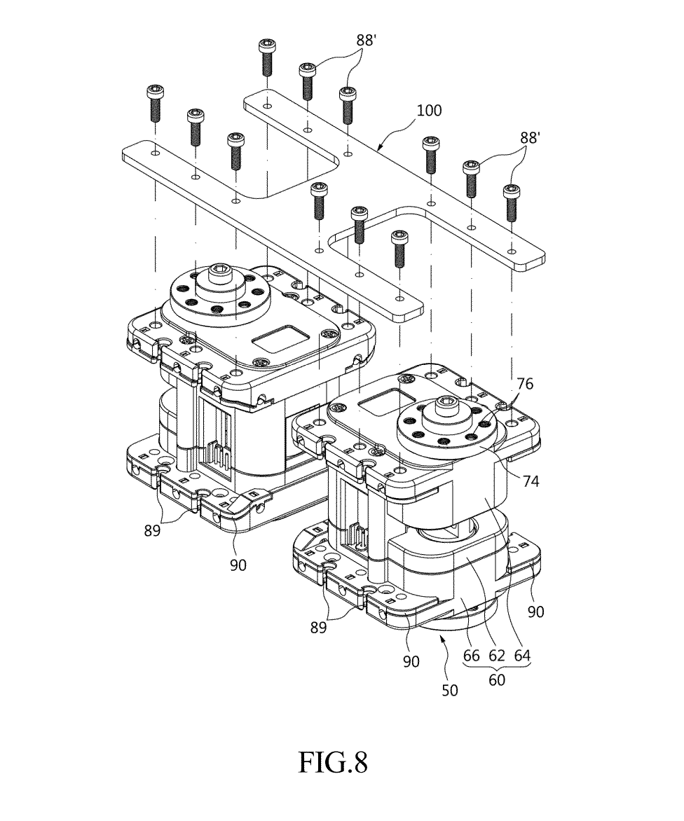

Meanwhile, in the present invention, the modular actuators 50 may be joined using various connecting members 100 and 100′. First, in FIG. 8, two modular actuators 50 are joined using an H-shaped connecting member 100. At this time, the intermediate output portions 70 of the modular actuators 50 are disposed to be directed in opposite directions.

The connecting member 100 is fastened to all of the first fastening parts 82 of the coupling pieces 80 formed in the first end housing 64 of one modular actuator 50 and also fastened to all the first fastening parts 82 of the coupling pieces 80 formed in the first end housing 64 of the other modular actuator 50.

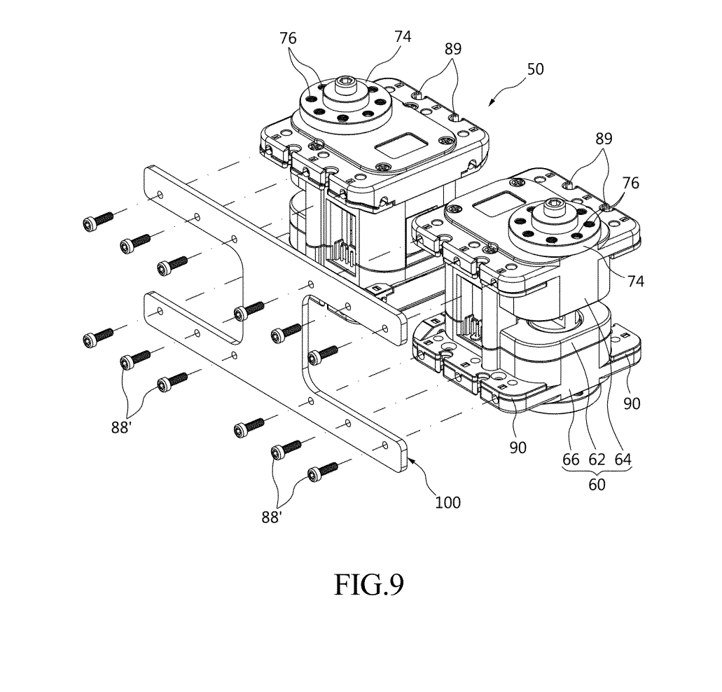

FIG. 9 illustrates two modular actuators 50 joined using the connecting member 100 at a position which is different from the position illustrated in FIG. 8. Here, the connecting member 100 is coupled to all of the second fastening parts 84 of the coupling pieces 80 formed in the first and second end housings 62 and 64 of one modular actuator 50. The connecting member 100 is also coupled to the other modular actuator 50 in the same manner. The state illustrated in FIG. 9 is the same as that illustrated in FIG. 8 in the arrangement of the modular actuators 50. However, since the outer surfaces of the modular actuators 50 which are not shielded by the connecting member 100 become different from those of the modular actuators 50 in FIG. 8, the modular actuators 50 joined as illustrated in FIG. 9 may be used differently from those of FIG. 8.

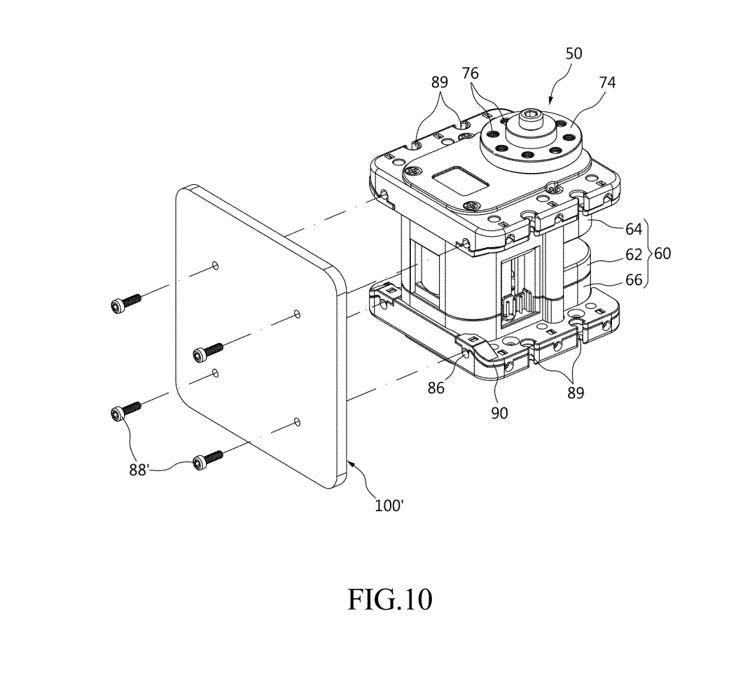

Finally, FIG. 10 illustrates a connecting member 100′ mounted on one modular actuator 50 using the third fastening parts 86 in the modular actuator 50. The connecting member 100′ may allow the modular actuator 50 to be fixed by being fastened to any other component in the state where the connecting member 100′ is mounted on the modular actuator 50.

Besides the methods illustrated in FIGS. 7 to 10, there are various methods for fastening various components to one modular actuator 50. This is enabled because, the first, second, and third fastening parts 82, 84 and 86 are formed to be opened in orthogonal directions in the present invention.

Although the technical idea of the present invention has been described above merely for illustrative purpose, various changes and modifications may be made by a person ordinarily skilled in the art to which the present invention belongs without departing from the essential features of the present invention. Accordingly, the exemplary embodiments disclosed in the present application are provided for illustrating the technical idea of the present invention but are not intended for limiting the technical idea, and the technical idea and scope of the present invention shall not be limited by the exemplary embodiments. The scope of the present invention to be protected shall be interpreted based on the accompanying claims and all the technical ideas equivalent thereto shall be interpreted as being included in the scope of the present invention to be protected.

For example, although the output opening portion 68 is formed at one side of the housing 60 such that driving force can be transferred to the outside through the intermediate portion and the opposite end portions of the driving shaft in the illustrated exemplary embodiment, it is not essential and the driving force may be made to be transferred through an end portion and/or the intermediate portion of the driving shaft.

In addition, although the nuts 88 are respectively installed at the first, second, and third fastening parts 82, 84 and 86 in the illustrated exemplary embodiment, it is not essential and threads may be formed on inner surfaces of the first, second, and the third fastening holes 82′, 84′ and 86′ instead of the nuts 88.

### DESCRIPTION OF REFERENCE NUMERALS

50: modular actuator
60: housing
62: main housing
64: first end housing
66: second end housing
68: output opening portion
70: intermediate output portion
72: fastening through-hole
74,74′: first and second output joints
76: fastening through-hole
78: connector seat
80: coupling piece
82: first fastening part
82′: first fastening hole
84: second fastening part
84′: second fastening hole
86: third fastening part
86′: third fastening hole
88: nut
88′: bolt
89: cable hooking slot
90: cover
92: inner space
94: cover fastening boss
96: nut seat
98: cover fastening hole

What is claimed is:

1. A modular actuator joining device comprising:
a housing that forms an external appearance and encloses a driving source therein such that a driving force of the driving source can be transferred to outside through a driving shaft;
a coupling piece formed on an outer surface of the housing to have a predetermined thickness and protruding by a predetermined width;
a first fastening part where a first fastening hole is formed to be opened to another outer surface of the coupling piece so that a fastener is fastened to the first fastening hole so as to join a component; and
a second fastening part where a second fastening hole is formed to be opened to another outer surface of the coupling piece in a direction orthogonal to an opening direction of the first fastening hole so that a fastener is fastened to the second fastening hole to join another component.

2. The modular actuator joining device of claim 1, wherein the first fastening hole that forms the first fastening part is formed through the coupling piece in a thickness direction, and a nut is installed inside the first fastening hole.

3. The modular actuator joining device of claim 2, wherein the second fastening hole that forms the second fastening part is formed to be opened to a front end surface of the coupling piece and a nut is installed inside the second fastening hole.

4. The modular actuator joining device of claim 3, further comprising a third fastening part at still another outer surface of the coupling piece,
wherein a third fastening opening is formed to be opened in a direction orthogonal to both the opening directions of the first fastening hole and the second fastening hole.

5. The modular actuator joining device of claim 4, wherein the third fastening part is formed on the outer surface positioned opposite to the driving shaft among the outer surfaces of the coupling piece.

6. The modular actuator joining device of claim 1, wherein the housing comprises a main housing and first and second housings installed at opposite ends of the main housing, and a plurality of coupling pieces are formed to protrude in opposite directions from opposite ends of the first and second end housings.

7. The modular actuator joining device of claim 6, wherein the coupling pieces are joined with covers, respectively, so that inner spaces formed in the coupling pieces are shielded by the covers, and wherein nut seats are formed in any of the inner spaces and nuts that form the first and second fastening parts are seated on the nut seats, respectively.

8. The modular actuator joining device of claim 7, wherein the nut seats are formed on at least one side of the first and second end housings and inner surfaces of the covers.

9. The modular actuator of claim 1, wherein the coupling piece is formed with a cable hooking slot where a cable is hooked to be fixed, the cable hooking slot being opened to all of a front end surface of the coupling piece and outer surfaces adjacent to the front end surfaces.
